(19) United States
(12) Patent Application Publication
(10) Pub. No.: US 2025/0093974 A1
(43) Pub. Date: Mar. 20, 2025

(54) ULTRASONIC MOUSE

(71) Applicant: SonicMEMS (ZhengZhou) Technology Co.,Ltd., Zhengzhou (CN)

(72) Inventors: Yi-Hsiang Chiu, Zhengzhou (CN); Rei Jinchi, Zhengzhou (CN); Hsien-Tsong Chen, Zhengzhou (CN)

(21) Appl. No.: 18/527,780

(22) Filed: Dec. 4, 2023

(30) Foreign Application Priority Data
Sep. 15, 2023 (TW) 112135411

(51) Int. Cl. G06F 3/0354; G06F 3/0362; G06F 3/038

(52) U.S. Cl. CPC G06F 3/03543; G06F 3/038; G06F 3/0362

(57) ABSTRACT

An ultrasonic mouse includes an ultrasonic module, a processing unit, and a transmission interface. The ultrasonic module includes an ultrasonic emitting element and a plurality of ultrasonic receiving elements, the ultrasonic receiving elements and the ultrasonic emitting element are arranged in a matrix, and the ultrasonic receiving elements are arranged surrounding the ultrasonic emitting element. The ultrasonic emitting element generates an ultrasonic signal. When the ultrasonic mouse moves, at least one of the ultrasonic receiving elements generates sensing information upon receiving the ultrasonic signal. The processing unit is electrically connected to the ultrasonic module, receives the sensing information, and calculates and generates a movement signal. The transmission interface is electrically connected to the processing unit, and transmits the movement signal out.

### CROSS-REFERENCE TO RELATED APPLICATION

This non-provisional application claims priority under 35 U.S.C. § 119 (a) to patent application No. 112135411 filed in Taiwan, R.O.C. on Sep. 15, 2023, the entire contents of which are hereby incorporated by reference.

### BACKGROUND

### Technical Field

The present invention relates to the field of computer peripherals, and in particular, to an ultrasonic mouse.

### Related Art

Currently, a mouse has become an indispensable input device for operating a computer. A mainstream mouse at present is optical. An operation principle of the mouse is to collect a position during movement of the mouse on a surface of an object by using an LED light source and a photoelectric sensor/or a small lens. Relative movement of the mouse on various surfaces is calculated by using a small image processing chip and based on a collected result, and a movement signal is transmitted to a computer, to make a cursor move on screen.

However, the optical mouse still has a disadvantage. A problem of insensitive sensing in a light-penetrating substance, such as glass, or a smooth surface still exists. Currently, the problem is mitigated by using manners, for example a laser light source, but overall costs are much higher than that by using a conventional LED light source.

### SUMMARY

Recently, with improving maturity of an ultrasonic sensor technology, costs are also greatly reduced. Conventional optical sensing is replaced by using ultrasonic in this application.

To resolve a problem faced by conventional technologies, an ultrasonic mouse is provided herein. The ultrasonic mouse includes an ultrasonic module, a processing unit, and a transmission interface. The ultrasonic module includes an ultrasonic emitting element and a plurality of ultrasonic receiving elements, the ultrasonic receiving elements and the ultrasonic emitting element are arranged in a matrix, and the ultrasonic receiving elements surrounds the ultrasonic emitting element. The ultrasonic emitting element generates an ultrasonic signal. When the ultrasonic mouse moves, at least one of the ultrasonic receiving elements generates sensing information upon receiving an ultrasonic reflected signal generated by reflection of the ultrasonic signal. The processing unit is electrically connected to the ultrasonic module, receives the sensing information, and calculates and generates a movement signal. The transmission interface is electrically connected to the processing unit, and transmits the movement signal out.

In some embodiments, the transmission interface is a wireless transceiver.

More specifically, in some embodiments, the ultrasonic mouse further includes a battery unit, where the battery unit supplies power to the ultrasonic module, the processing unit, and the transmission interface.

In some embodiments, the transmission interface is an electrical connector.

In some embodiments, the ultrasonic mouse further includes a casing, where the ultrasonic module, the processing unit, and the transmission interface are in the casing, the casing includes a slot, and the ultrasonic module is exposed from the slot.

More specifically, in some embodiments, the ultrasonic mouse further includes a button assembly, where the button assembly is in contact with a part of the casing and electrically connected to the processing unit, and the processing unit generates a corresponding operation instruction based on press on the button assembly.

More specifically, in some embodiments, the ultrasonic mouse further includes an auxiliary operating apparatus, where the auxiliary operating apparatus is mounted on the casing and electrically connected to the processing unit, and the processing unit optionally generates the movement signal based on an operation of the auxiliary operating apparatus.

Further, in some embodiments, the auxiliary operating apparatus is a scroll wheel.

Further, in some embodiments, the auxiliary operating apparatus is a trackball.

More specifically, in some embodiments, the ultrasonic mouse further includes an indicating element, where the indicating element is electrically connected to the processing unit, and the processing unit generates an indicating signal to start the indicating element when the ultrasonic mouse is abnormal.

As shown in the foregoing embodiments, a movement path of the ultrasonic mouse is calculated by using a manner for sensing ultrasonic reflection, so that a problem that sensing of a conventional optical mouse is affected by a material on which the conventional optical mouse is placed can be resolved.

### BRIEF DESCRIPTION OF THE DRAWINGS

FIG. 1 is an exploded view of a first embodiment of an ultrasonic mouse;

FIG. 2 is a three-dimensional diagram of the first embodiment of the ultrasonic mouse;

FIG. 3 is a schematic block diagram of an ultrasonic module of an ultrasonic mouse;

FIG. 4 is a schematic diagram of an operation of an ultrasonic mouse;

FIG. 5 is a block diagram of a circuit of the first embodiment of the ultrasonic mouse;

FIG. 6 is a three-dimensional diagram of a second embodiment of an ultrasonic mouse;

FIG. 7 is a three-dimensional diagram of a third embodiment of an ultrasonic mouse;

FIG. 8 is a three-dimensional diagram of a fourth embodiment of an ultrasonic mouse; and

FIG. 9 is a block diagram of a circuit of a third embodiment of an ultrasonic mouse.

### DETAILED DESCRIPTION

It should be understood that when an element is referred to as being “disposed” on another element, it may be indicated that the element is directly located on the another element, or there may be an intervening element, and the element is connected to another element by using the intervening element. In contrast, when an element is referred to as being “directly on another element” or “directly connected to another element”, it may be understood that it is clearly defined that there is no intervening element.

In addition, terms “first”, “second”, and “third” are intended only to distinguish an element, a component, a region, a layer, or a part from another element, component, region, layer, or part but do not necessarily indicate a specific order. In addition, relative terms such as “lower” and “upper” may be used herein to describe a relationship between one element and another element, and it should be understood that the relative terms are intended to include different orientations of an apparatus other than orientations shown in the figure. For example, if an apparatus in one of the accompanying drawings is flipped over, an element described as being on a “lower” side of another element is to be oriented on an “upper” side of the another element. This is only a relative orientation, not an absolute orientation.

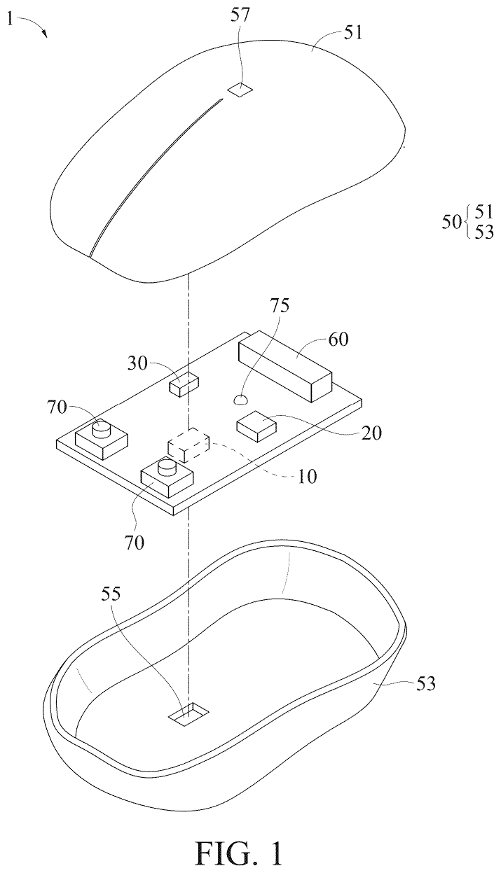

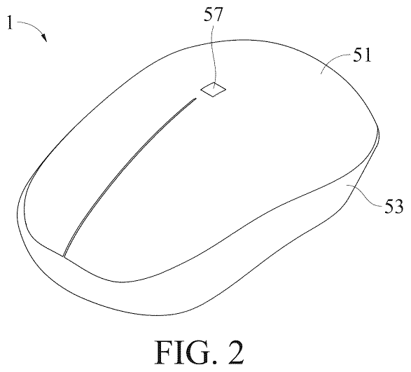

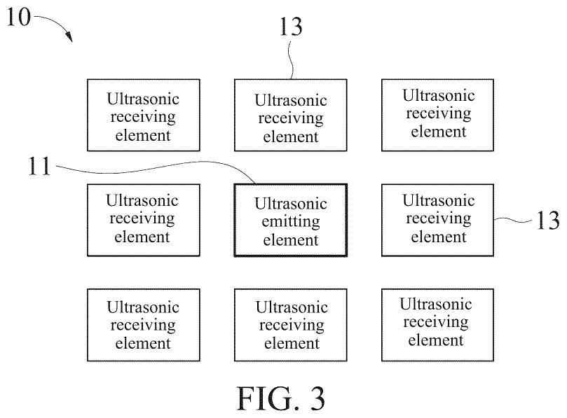

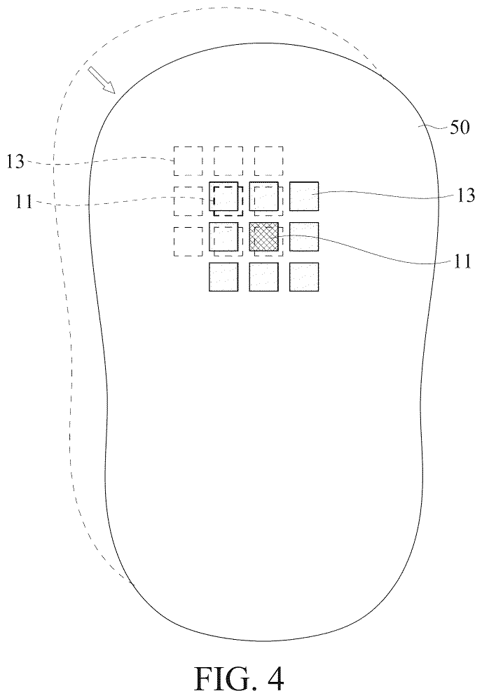

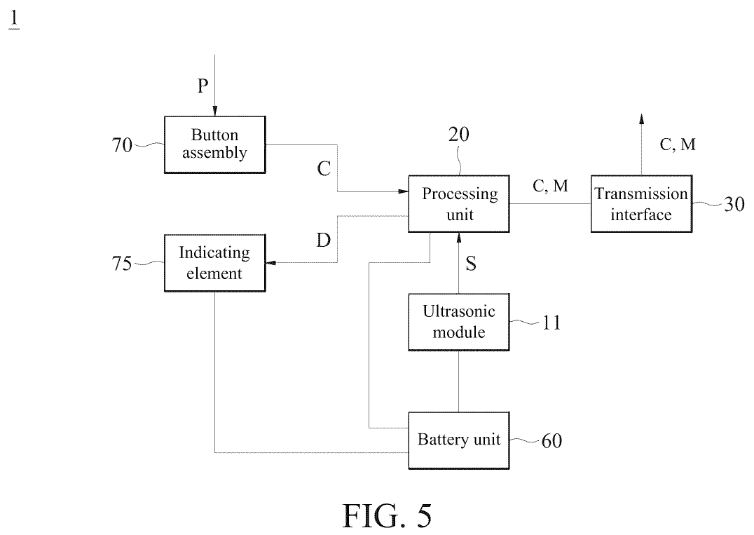

FIG. 1 is an exploded view of a first embodiment of an ultrasonic mouse. FIG. 2 is a three-dimensional diagram of a first embodiment of an ultrasonic mouse. FIG. 3 is a schematic block diagram of an ultrasonic module of an ultrasonic mouse. FIG. 4 is a schematic diagram of an operation of an ultrasonic mouse. FIG. 5 is a block diagram of a circuit of a first embodiment of an ultrasonic mouse. As shown in FIG. 1 to FIG. 5, an ultrasonic mouse 1 and an optical mouse are of a same appearance. The ultrasonic mouse 1 includes an ultrasonic module 10, a processing unit 20, and a transmission interface 30. The ultrasonic module 10, the processing unit 20, and the transmission interface 30 may be jointly configured in a circuit board 40 and protected by a casing 50. Here, the casing 50 may include a first casing 51 and a second casing 53 that are connected to each other to accommodate elements mounted on the circuit board 40. The second casing 53 is provided with a slot 55 to enable the ultrasonic module 10 to be exposed.

As shown in FIG. 3, the ultrasonic module 10 includes an ultrasonic emitting element 11 and a plurality of ultrasonic receiving elements 13, the ultrasonic emitting element 11 and the ultrasonic receiving elements 13 are arranged in a matrix, and the ultrasonic receiving elements 13 surrounds the ultrasonic emitting element 11. Here, the ultrasonic emitting element 11 and the ultrasonic receiving elements 13 are arranged in a nine-cell pattern, and the ultrasonic emitting element 11 is at the center, but this is merely an example and not intended to be a limitation, and there may actually be a plurality of ultrasonic emitting elements 11. Both the ultrasonic emitting element 11 and the ultrasonic receiving elements 13 may be Piezoelectric Micromachined Ultrasonic Transducers (Piezoelectric Micromachined Ultrasonic Transducers, PMUTs).

As shown in FIG. 4 and FIG. 5, here, to present a movement state, a proportion of the ultrasonic module 10 is exaggerated. The ultrasonic emitting element 11 generates an ultrasonic signal. When the ultrasonic mouse 1 moves, at least one of the ultrasonic receiving elements 13 generates sensing information S upon receiving an ultrasonic reflected signal generated by reflection of the ultrasonic signal. For example, a user operates the ultrasonic mouse 1 to move to a lower right side, and an ultrasonic receiving element 13 in an upper left side is to receive the ultrasonic reflected signal and generate the sensing information S. The processing unit 20 is electrically connected to the ultrasonic module 10, receives the sensing information S, and calculates and generates a movement signal M. For example, a moving track of the ultrasonic mouse 1 is calculated in reverse based on the sensing information S. The transmission interface 30 is electrically connected to the processing unit 20, and transmits the movement signal M out, so that a corresponding mouse track is generated on a computer. Here, the ultrasonic emitting element 11 may continuously or indirectly generate ultrasonic signals, or may be hibernated based on movement time of the ultrasonic mouse 1 when the ultrasonic mouse 1 stops moving for a period of time.

Still refer to FIG. 1 and FIG. 2. In some embodiments, the ultrasonic mouse 1 is a wireless mouse, and the transmission interface 30 is a wireless transceiver at this time. Further, the ultrasonic mouse 1 further includes a battery unit 60. The battery unit 60 supplies power to the ultrasonic module 10, the processing unit 20, and the transmission interface 30, and the battery unit 60 may be jointly disposed on the circuit board 40.

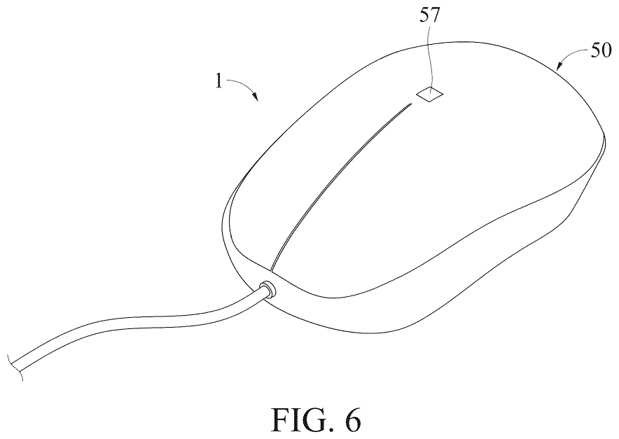

FIG. 6 is a three-dimensional diagram of a second embodiment of an ultrasonic mouse. Unlike the first embodiment, the ultrasonic mouse 1 is wired, and the transmission interface 30 is an electrical connector at this time. The ultrasonic mouse 1 may be connected to the transmission interface 30 and a connection interface of a computer (not shown) through a cable to transmit electrical energy and a signal.

Still refer to FIG. 1, FIG. 2, FIG. 5, and FIG. 6. The ultrasonic mouse 1 further includes a button assembly 70. The button assembly 70 may be mounted on the circuit board 40, may be in contact with a part of the first casing 51, and electrically connected to the processing unit 20. The processing unit 20 generates a corresponding operation instruction C based on press P on the button assembly 70, and then transmits the operation instruction C out by using the transmission interface 30.

In addition, the ultrasonic mouse 1 further includes an indicating element 75. The indicating element 75 is disposed on the circuit board 40 and electrically connected to the processing unit 20. When the ultrasonic mouse 1 is abnormal, for example, when power is insufficient, the processing unit 20 generates an indicating signal D to start the indicating element 75. The indicating element 75 may be an LED light, a vibration unit, or the like. Here, a casing 50 may be provided with an opening 57 to correspond to the LED light as the indicating element 75, but this is only for an example and not for limitation.

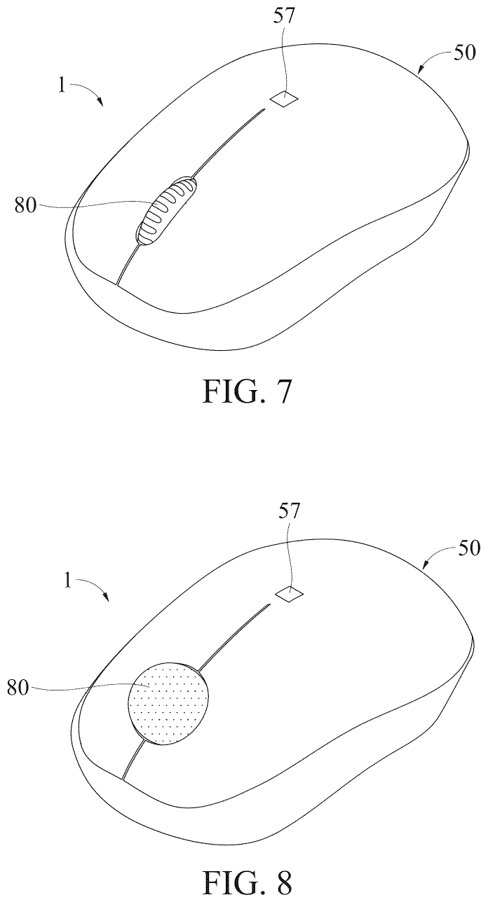

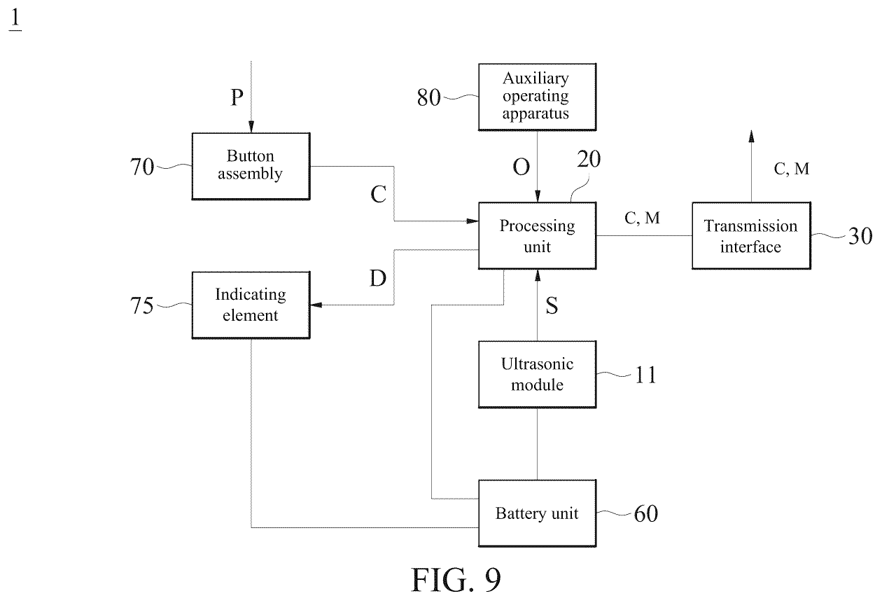

FIG. 7 is a three-dimensional diagram of a third embodiment of an ultrasonic mouse. FIG. 8 is a three-dimensional diagram of a fourth embodiment of an ultrasonic mouse. FIG. 9 is a block diagram of a circuit of a third embodiment of an ultrasonic mouse. As shown in FIG. 7 to FIG. 9, the ultrasonic mouse 1 further includes an auxiliary operating apparatus 80. The auxiliary operating apparatus 80 is mounted on the casing 50 and electrically connected to the processing unit 20. The processing unit 20 optionally generates the movement signal M based on an operation O of the auxiliary operating apparatus 80. In other words, the ultrasonic mouse 1 may also perform an operation in combination with the mechanical auxiliary operating apparatus 80. The auxiliary operating apparatus 80 may be a scroll wheel as shown in FIG. 7, or a trackball as shown in FIG. 8.

In conclusion, the ultrasonic mouse 1 calculates a movement path of the ultrasonic mouse 1 by using a manner for sensing ultrasonic reflection, so that a problem that sensing of a conventional optical mouse is affected by a material on which the conventional optical mouse 1 is placed can be resolved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

1. An ultrasonic mouse, comprising:
an ultrasonic module, wherein the ultrasonic module comprises an ultrasonic emitting element and a plurality of ultrasonic receiving elements, the ultrasonic receiving elements and the ultrasonic emitting element are arranged in a matrix, the ultrasonic receiving elements surrounds the ultrasonic emitting element, the ultrasonic emitting element generates an ultrasonic signal, and when the ultrasonic mouse moves, at least one of the ultrasonic receiving elements generates sensing information upon receiving an ultrasonic reflected signal generated by reflection of the ultrasonic signal;
a processing unit, wherein the processing unit is electrically connected to the ultrasonic module, receives the sensing information, and calculates and generates a movement signal;
a transmission interface, wherein the transmission interface is electrically connected to the processing unit, and transmits the movement signal out; and
a casing comprising a slot, wherein the ultrasonic module, the processing unit, and the transmission interface are in the casing, and the ultrasonic module is exposed from the slot.

2. The ultrasonic mouse according to claim 1, wherein the transmission interface is a wireless transceiver.

3. The ultrasonic mouse according to claim 2, further comprising a battery unit, wherein the battery unit supplies power to the ultrasonic module, the processing unit, and the transmission interface.

4. The ultrasonic mouse according to claim 1, wherein the transmission interface is an electrical connector.

5. (canceled)

6. The ultrasonic mouse according to claim 1, further comprising a button assembly, wherein the button assembly is in contact with a part of the casing and electrically connected to the processing unit, and the processing unit generates a corresponding operation instruction based on press on the button assembly.

7. The ultrasonic mouse according to claim 51, further comprising an auxiliary operating apparatus, wherein the auxiliary operating apparatus is mounted on the casing and electrically connected to the processing unit, and the processing unit optionally generates the movement signal based on an operation of the auxiliary operating apparatus.

8. The ultrasonic mouse according to claim 7, wherein the auxiliary operating apparatus is a scroll wheel.

9. The ultrasonic mouse according to claim 7, wherein the auxiliary operating apparatus is a trackball.

10. The ultrasonic mouse according to claim 51, further comprising an indicating element, wherein the indicating element is electrically connected to the processing unit, and the processing unit generates an indicating signal to start the indicating element when the ultrasonic mouse is abnormal.
